(19) United States
(12) Patent Application Publication
(10) Pub. No.: US 2009/0177601 A1
(43) Pub. Date: Jul. 9, 2009

(54) STATUS-AWARE PERSONAL INFORMATION MANAGEMENT

(75) Inventors: Chao Huang, Beijing (CN); Chunhui Zhang, Beijing (CN); Frank Kao-ping Soong, Warren, NJ (US); Zhengyou Zhang, Bellevue, WA (US); Yuan Kong, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/970,522

(22) Filed: Jan. 8, 2008

(51) Int. Cl. G06F 15/18

(52) U.S. Cl. 706/16

(57) ABSTRACT

Described is a technology by which personal information that comes into a computer system is intelligently managed according to current state data including user presence and/or user attention data. Incoming information is processed against the state data to determine whether corresponding data is to be output, and if so, what output modality or modalities to use. For example, if a user is present and busy, a notification may be blocked or deferred to avoid disturbing the user. Cost analysis may be used to determine the cost of outputting the data. In addition to user state data, the importance of the information, other state data, the cost of converting data to another format for output (e.g., text-to-speech), and/or user preference data, may factor into the decision. The output data may be modified (e.g., audio made louder) based on a current output environment as determined via the state data.

### BACKGROUND

In contemporary computing, many user interface outputs are not particularly user-friendly with respect to how and when they appear. In general, such user interfaces are system (or machine) driven instead of user-centric.

By way of example, there are currently many kinds of information delivered to computer users from time to time without considering whether the user and his and/or her machines are currently busy. For example, when a user is busy composing a document, a computer system may download security updates and remind the user to update the system with them. When in a business meeting or giving a presentation, instant messages and other personal and/or irrelevant reminders may keep popping up. This is not only distracting, but also may lead to personal information being viewable by others.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which state data including user presence and/or user attention data is used to determine whether a set of information is to be output as corresponding data to a selected candidate output modality (e.g., of a plurality of output mechanisms). In this way, personal information is intelligently managed with respect to when and how it is output to a user.

Information may be received from a remote source, from a reminder source, and may have been previously cached for later possible output. The user presence and attention data may comprise audio signals, video signals, keyboard and/or mouse activity signals and/or calendar data. Output types corresponding to output modalities may include a display for text/graphics/video/animation, a speaker for audio output (e.g., text to speech, tones and so forth), a vibration mechanism, a storage, another device, and so forth.

In one aspect, a set of information is processed to determine whether to output corresponding data, including by computing a cost associated with outputting the data to a selected candidate modality. A lowest cost path analysis may be used. Further, various costs may be computed and compared, e.g., a first information cost and a second cost of outputting the data on a selected candidate modality, to determine whether to output the data to that modality. User state, other state, conversion cost (e.g., text to speech), and user preferences and other data may be considered in the computation. If output is determined, the output data may be modified based on a current output environment as determined via the state data.

In one example implementation, a manager component processes sets of information and obtains state data including user presence and attention data. An output mechanism coupled to the manager component is selected and the manager component determines whether to output data corresponding to a set of incoming information to that selected output mechanism based on the current user state as determined from the presence and attention data. The manager component may be coupled to logic that routes information to at least one of the output mechanisms and converts the information into a suitable output type as appropriate for each output mechanism. The manager component may be coupled to further logic that determines from the state data whether, and if so when, to output the data corresponding to the information to each output mechanism. The manager component may compute costs related to outputting data corresponding to the information to the output mechanisms.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing aspects of managing incoming personal information with respect to whether and how to output data corresponding to that incoming information based on user state data and other data.

FIG. 2 is a representation of various components in a status aware personal information manager that manages information output.

FIG. 3 is a flow diagram representing example steps taken to process incoming information for possible output depending on user state and other data.

FIG. 4 shows an illustrative example of a computing environment into which various aspects of the present invention may be incorporated.

### DETAILED DESCRIPTION

Various aspects of the technology described herein are generally directed towards managing information coming into a computer system and providing a corresponding output through one or more appropriate modalities and at an appropriate time. The management is based upon a user's current state (status), and possibly other data (e.g., user preference data, importance of the incoming information, and so forth). There is thus provided status-aware personal information management that operates in what is perceived to be an intelligent, or smart, manner. In general, instead of a system-driven message/information broadcast system, there is provided a more friendly, presence-aware and user-centric communication and information transfer mechanism and process.

In one aspect, smart personal information management generally acts as an information filter. However, beyond merely removing truly unnecessary information such as spam and other junk email messages, smart personal information management further delivers filtered information to a user in an appropriate time with an appropriate modality according to the users' current status. By operating in such a user-centric manner, a more user friendly experience is realized instead of disturbing the user with unnecessary, irrelevant, untimely or otherwise inappropriate information.

While many of the examples herein are described with respect to a personal computer, it is understood that virtually any computing device that is coupled to one or more sensors or can otherwise detect user state information is capable of implementing smart personal information management. For example, a GPS-enabled mobile computing device can determine state information by changing coordinates, e.g., when a device is moving it is known that the device is likely present with the user even at times when the user is not interacting with the device. At such a time, audio and/or vibration may likely provide a better notification output than visible output, whereas visible output may be more appropriate at times when the user is known to be interacting with the device.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and information management in general.

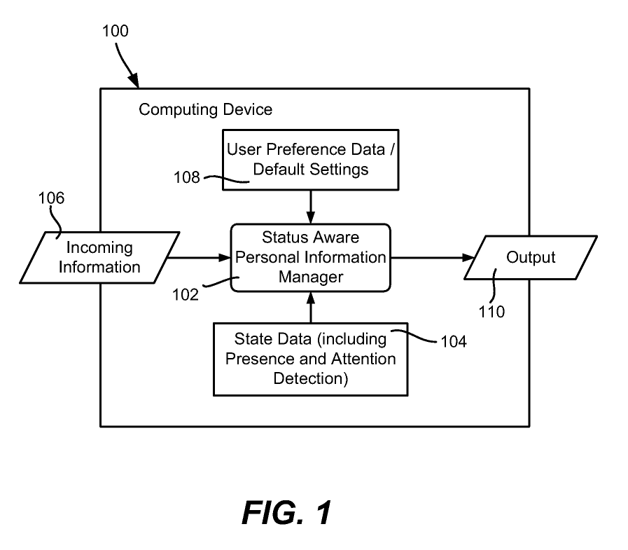

Turning to FIG. 1, there are shown example components which may be used to implement status aware, smart personal information management on a computing device 100. As described below, a personal information manager 102 is aware of a user's current state (is status aware) by way of being coupled to state data 104. As described herein, such state data 104 generally includes user presence and attention data that may be sensed by any type of sensor, but also may include other variable state data, such as time of day, day of week, current location of the computing device 100, whether the device is moving, whether the device is connected to a network, what program is being run, whether the display is being projected to others, and so forth. Presence generally refers to whether the user is sufficiently close to the output device to receive its output data, while attention generally refers to whether the user will likely notice the output data. For example, a user may be detected as being present when in his office, but will be deemed not attentive to data rendered on a monitor if sensed to be looking out his window; at the same time, if the office is sensed as being reasonably quiet, such a user will be deemed attentive with respect to being capable of hearing an audible signal.

As incoming information 106 arrives, the status aware personal information manager 102 processes the incoming information 106 in conjunction with user preference data (and/or default settings) 108. If not filtered out completely, e.g., as are known junk emails, the status aware personal information manager 102 uses the state data 104 to compute whether (and if so, via what modality or modalities) to generate appropriate state-based output 110 that corresponds to the incoming information and output mechanisms' capabilities, e.g., to output the information 106 (such as text) itself, convert the information 106 to another format (such as text-to-speech) for the output 110, convert the information 106 to one or more types of notifications for the output 110, and so forth.

Further, the status aware personal information manager 102 processes the incoming information 106, the user preference data (and/or default settings) 108 and the state data 104 to determine a time (or a set of times) for the output or outputs. For example, output may be immediate, or may be buffered or otherwise persisted for later output, e.g., as a notification the next time the user is detected as interacting with the computing device. Multiple outputs and times may be generated, e.g., an immediate audible notification may be generated, with a visible output for the same incoming information triggered by some later event.

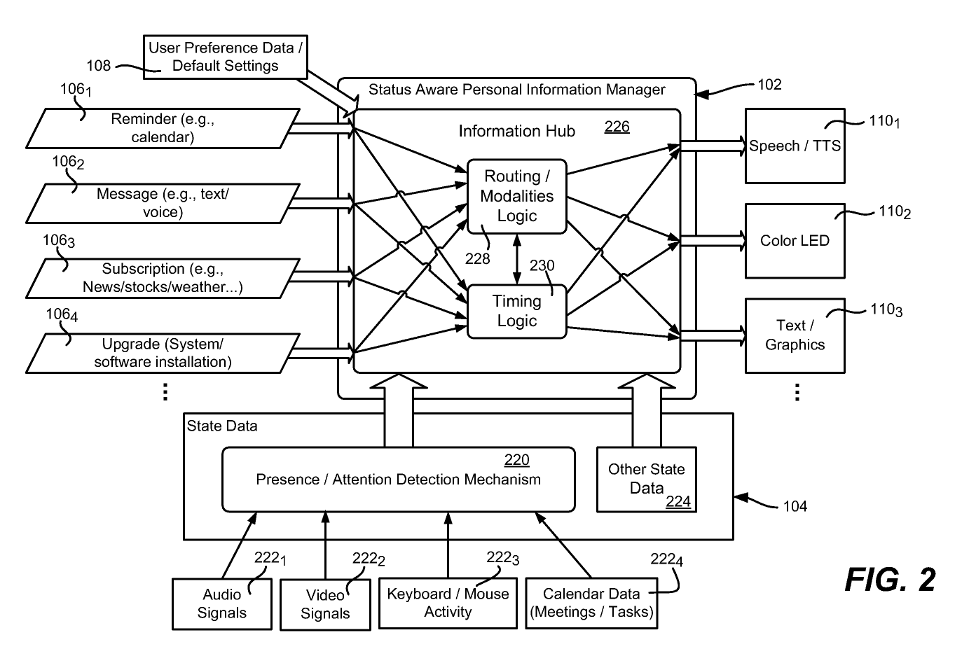

FIG. 2 represents example internal components of one status aware personal information manager 102, along with examples of some possible types of input information 106₁-106₄, possible types of outputs 110₁-110₃ and various state data. FIG. 2 also represents a user presence and/or user attention detection mechanism 220 that provides various types of user presence and/or user attention input sensors 222₁-222₄ as part of the state data 104, which may also include other state data 224 as exemplified above.

As generally represented in FIG. 2, user presence and/or user attention can be sensed and/or inferred in a number of ways, including via the input sensors 222₁-222₄. For example, an audio signal sensor may 222₁ detect user presence through speech or other sound detection, and can also be used to determine an attention (busy) level by differentiating between microphone-directed speech, telephone speech, in-person conversation speech and so forth. A video signal sensor (block 222₂, e.g., signals from a video camera) can detect presence, and can also be analyzed using facial recognition technology and the like to determine who is present, where that user is currently looking, and so forth. Keyboard and/or mouse activity sensing (block 222₃) indicates both presence and a busy state, (at least busy to a certain extent). Calendar data sensing 222₄ such as data that reflects meetings and/or tasks can also provide information as to a user's whereabouts and/or a busy level. Note that these types of state data 104 represented in FIG. 2 are only examples, as in general, many other types of sensors (motion sensors, heat sensors, GPS sensors, proximity sensors and so forth) may provide useful information related to presence and attention detection.

Thus, in general, the status aware personal information manager 102 can determine a current status of the user, such as busy (on phone, working on computer, having a discussion in the room with others), not busy (in room alone, off computer), or totally unavailable (away, offline). Note that even when determined to be totally unavailable, the status aware personal information manager 102 may still take some action when incoming data is received, for example to automatically forward data (a message and/or a notification) to a user's mobile device.

By way of other examples, when via the state data 104 the user is deemed busy, the status aware personal information manager 102 can report a user's busy status to other computers, block any incoming information to avoid bothering the user, and/or postpone any messages/reminders until sometime later when the user is available and not as busy. In contrast, when via the state data 104 the user is deemed present but not busy nor viewing the display, the status aware personal information manager 102 may provide audible notifications and/or other distantly noticeable notifications (e.g., by lighting an LED) as information is received.

Also represented in FIG. 2 as being incorporated into or otherwise associated with the status aware personal information manager 102 is an information hub 226. In general, the information hub 226 is in charge of collecting the various types of information that may be delivered to a user, such as reminders 106₁, (e.g., of meetings/follow-ups), messages 106₂, (e.g., email, instant messages, voice messages, incoming calls, text messages and so on), subscripted materials 106₃ (e.g., stock/weather/news reports from websites), upgrade/security package installation requirements 106₄, and so forth.

To this end, in one example implementation the status aware personal information manager 102 includes routing/modalities logic 228 for processing and/or routing incoming data to one or more appropriate output channels so that the appropriate output is received by the output mechanisms. More particularly, in addition to routing the data to the correct output, the logic 228 considers modalities as to how the data is to be output with respect to current state data. For example, the input information may be in the form of text, which can be output as the actual text itself, converted (by text-to-speech, or TTS technology) to speech and output as speech, converted to a notification that indicates text is available, and/or other modes of output. A notification may be in the form of other text or graphics, an illuminated set of one or more indicators such as LEDs (with variable color, flash patterns, intensities and the like), an audible beep (with variable pitches, lengths, intensities and the like), a vibration (with variable vibration patterns and the like), and so forth. If an output is deemed appropriate based on the current user state (and possibly the importance of the information and user preferences), the routing/modality logic 228 selects one or more outputs and converts modalities as appropriate, and routes the corresponding appropriate output to the corresponding output mechanism or mechanisms.

As can be readily appreciated, the state data 104 may change during output, resulting in a change in output modalities. For example, information in the form of an ongoing text chat can be transferred to mobile device via TTS technology when a user leaves the computer but wants to keep the discussion going.

Moreover, output may be conditioned to fit a current environment as detected via current state data 104. For example, a loud environment may be detected, whereby a louder audio output may be generated by the modalities logic 228. Similarly, a bright environment may require a change in backlighting, for example. If a user is currently looking away from the display, a notification may pop up longer than if the user currently looking, and may even remain popped-up until the user looks at the display. However, note that if the user is deemed busy, the notification may not appear at all to avoid distraction, regardless of whether the user is looking at the display. Still further, the type and/or importance of the information may weigh on the decision, e.g., a calendar reminder may pop up, whereas a stock price update may not.

Timing logic 230 is also used to decide when (and whether) to output data. For example, based on detected state that indicates that the user is in the room but not in front of the computer, the timing logic 230 may immediately output an audible sound and illuminate an LED, while buffering display monitor output (e.g., video, text and/or graphics, animation) for display at a time when the user is looking at the display. If a user is not present at all, no output may be generated (although some indication may be output as a failsafe), or output data (or data that will generate an output) may be forwarded to another device.

With respect to software updates, updating a computer may be considered as another form of outputting data (e.g., to a hard drive), and thus may be controlled by the timing logic 230. For example, downloading and/or installing an update or set of updates may be postponed until a time when the user is detected by the presence/attention detection mechanism as not busy or not present or both, possibly after waiting for a certain length of time. Time of day may be a factor, e.g., updates may be postponed until a user is not only not busy and/or present, but is also not likely to resume working, such as at midnight.

Multiple types of output may be generated for the same piece of information, at possibly different times. For example, an audible notification may be output indicating that a text message has been received, with the text of the message later output when the user is looking at the screen. A notification may appear indicating that content is ready for download, with an automatic download performed at a later time. Any system reboot that is required will not automatically occur at a time when the user is interacting with the system.

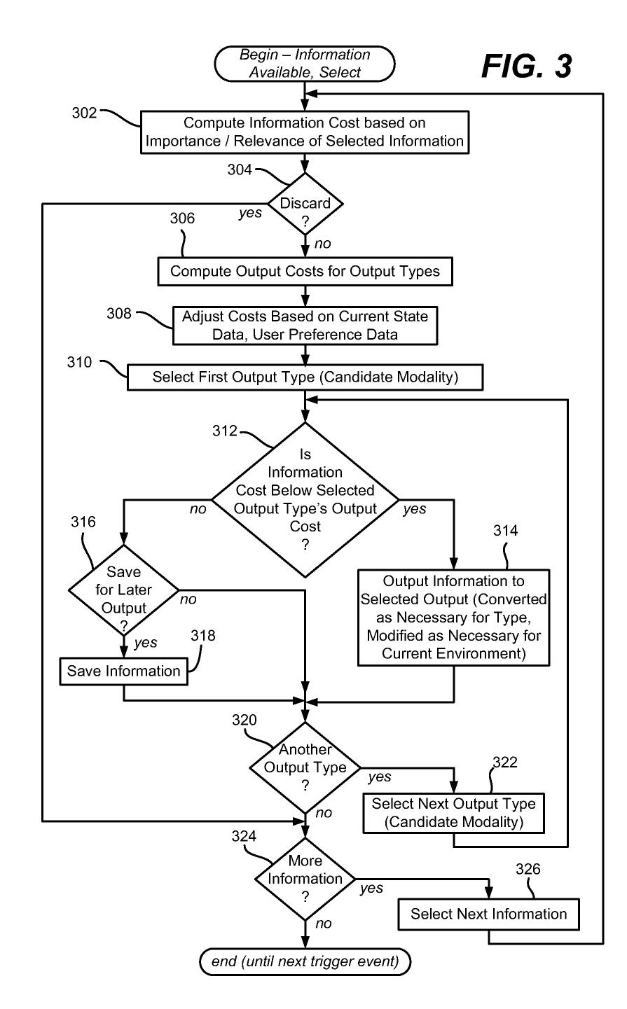

Turning to FIG. 3, there is described one example of how routing/modalities logic 228 and timing logic 230 may use state data 224 to provide status aware personal information management when processing received input information. Note that the steps of FIG. 3 are only examples, and further, that many of them may be executed in a different order. The example steps of FIG. 3 are triggered when some event occurs, such as new information being received, a time-based trigger, and/or when a state change indicates that a user is now able to sense (view/hear/feel) information that was buffered due to the user's previous inability to sense it.

Step 302 represents computing a cost based on the importance and/or relevance of a selected set of information to be processed for possible output, where a lower cost corresponds to more important and/or relevant information; (a higher “weight” is equivalent to a lower cost, and vice-versa). For example, via the preference data 108 a user may indicate that email messages received from a supervisor are highly important/relevant, whereby a low cost may be associated with messages from that supervisor. At the same time, known junk email may be computed to have a very high cost, whereby such a message will be discarded, or alternatively kept but only output to a junk mail folder with no corresponding notification, for example. Such cost data may be computed dynamically or may be maintained in the system, such as part of the preference data 108.

As can be readily appreciated, a cost of a set of information may be computed in virtually any way, e.g., by summing costs determined according to various criteria, including according to user preference data. For example, a computed cost for a set of information may consider its type (e.g., email versus an instant message versus a stock quote versus calendar data), its source (e.g., a supervisor), how old it is (which may be relative to its type), and so forth.

Step 304 represents evaluating whether to discard the selected information, such as based on its cost versus a maximum allowed cost. In this manner, for example, there is avoided further unnecessary computation for very costly information, such as for once-buffered but now expired notifications, junk messages that are automatically discarded, and so forth. If discarded, the example branches to step 324 to looks for whether there is another set of incoming or previously buffered information to process.

If not discarded by step 304, output costs are computed for various output types at step 306 in this example. This may include a cost for switching modalities. For example, there is a computational expense associated with converting text to speech, which thus corresponds to a higher cost than simply leaving text as is for output, which has essentially no cost. There is also a cost associated with converting specific information, such as text, to a simpler type of notification, such as an LED signal, in that only the simpler notification rather than the specific information may be seen by the user, at least for some time, whereby the amount of information that is conveyed is reduced.

Step 308 represents adjusting the information and/or output costs based on the current state data and/or user preference data. For example, if a user is detected as being in the room but not currently at the computer, the cost of displaying output on the monitor may be significantly increased because the user will not likely see it. However, in such a state, the cost of sounding an audible notification will decrease (or remain the same), as will the cost of driving an LED because the user may view the LED from a distance. The cost of routing the information to a mobile device may likewise decrease or remain the same. As another example of state data, when the user is giving a presentation, the cost of displaying visible data text or graphics may be set to the maximum, while the cost of routing the information to a mobile device may be reduced. As a result, the user's mobile device may buzz, but the presentation will not be overlaid with any visible output.

Further, other user preference data may factor into the computed output costs. For example, a user may specify that no instant message notifications are to appear when the user is in a busy state, e.g., as determined by presence/attention data such as a certain amount of interaction with the keyboard and/or mouse sensor (block 222₃) in conjunction with being in front of the display sensor (block 222₂). The user preference data thus may be used to increase the cost of instant message notifications when in a busy state.

As can be readily appreciated, given a set of costs corresponding to the various criteria, a lattice may be formed, through which a lowest cost path algorithm or the like may be used to select the lowest output cost or costs, with appropriate output generated. However, multiple types of outputs may be desired, as may buffering input information (or corresponding output data) for later output. The remainder of FIG. 3 shows how cost data may be used to drive multiple outputs and/or buffer information for possible later output.

Step 310 selects a first type of output mechanism from those available, and step 312 represents evaluating the computed cost for the information against the cost of outputting data corresponding to that information on the selected type of output mechanism. Note that user preference data may factor into the computed costs. If the cost comparison results in output being routed to the selected output mechanism, step 314 is executed where the information is output as appropriate, including any modality conversion and/or modification for the current environment (e.g., loud audio in a noisy environment).

By way of example, a text/graphics display may be selected as a candidate output type at step 310, and the computed and adjusted cost for that mechanism compared against the cost computed for the type of information. If the information is already text or graphics there is no modality conversion cost factor, and, if the user is present but not busy, then based on the cost comparison, it is likely that the information will be output as text/graphics (at step 314). However, if the information is speech that needs to be converted to text, and the user is deemed busy, then there is a lesser likelihood that the information will be output as text or graphics. If the next selected output type candidate (step 322) is audio output, however, the conversion cost factor is less and thus there is a greater likelihood that it will be output.

If not output to the selected candidate type, step 316 represents determining whether the information is of a type that is to be buffered for later possible output. Note that such buffering is in addition to conventional program output; for example, an email message that is received is already maintained by the email program, and it is unlikely that a user wants a notification at a later time that it was received awhile ago. However, a user may want a list of instant message notifications that came in but were blocked while the user was absent or busy. Step 318 represents saving information (e.g., the input information, corresponding output data or data from which corresponding output data may be generated) for incoming information that was not output on a particular type of output mechanism but still may be output at a later time. Thus, for example, an LED may flash for information while the user is not in front of the display, indicating that new information is available, with the text of that information buffered for later display (e.g., if still sufficiently timely such that its cost does not grow too high).

Steps 320 and 322 repeat the input information processing for each different type of possible output. Note that although not explicitly shown in FIG. 2, one output type may be to a storage (e.g., for installing updates), another may be to route information to another device such as a mobile device, and so forth.

When there are no more types of output to be considered, step 320 branches to step 324 where the process is repeated until no more information remains to be processed. In this manner, sets of new information and/or buffered information are each processed to determine whether and how to output notifications and/or data, as well as whether to buffer information for later possible output. When such information has been processed, the example steps of FIG. 3 end until some triggering event restarts the process, e.g., new information is received, user presence and/or attention state changes, a time-based trigger occurs, and so forth.

### Exemplary Operating Environment

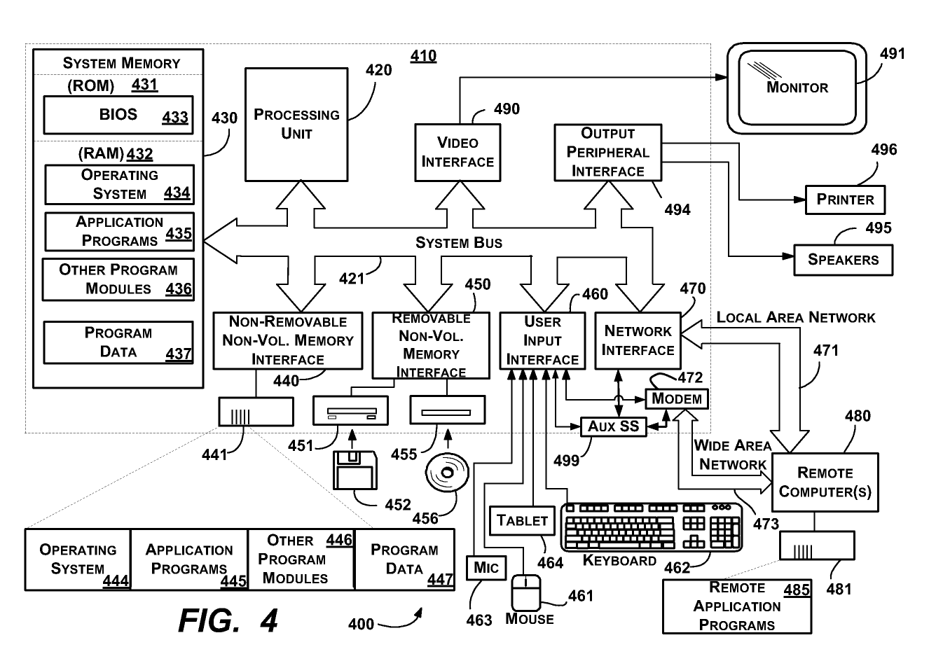

FIG. 4 illustrates an example of a suitable computing system environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising,
obtaining state data including user presence or user attention data, and both user presence and user attention data; and
processing a set of information to determine whether to output data corresponding to that information based on the state data and a selected candidate modality to use to output the data.

2. The method of claim 1 further comprising receiving the input information from a remote source, or receiving the input information from a reminder source.

3. The method of claim 1 wherein obtaining the state data comprises receiving audio signals, video signals, keyboard or mouse activity or both keyboard and mouse activity signals, calendar data, or any combination of audio signals, video signals, keyboard or mouse activity signals or both keyboard and mouse activity signals, or calendar data.

4. The method of claim 1 wherein processing the set of information to determine whether to output data comprises computing a cost associated with outputting the data corresponding to that information to the selected candidate modality.

5. The method of claim 4 further comprising outputting the data to the selected candidate modality based on a lowest cost path analysis.

6. The method of claim 1 wherein processing the set of information comprises computing a first cost associated with outputting the data corresponding to that information and a second cost of outputting the data on a selected candidate modality, and determining whether to output the data on the selected candidate modality based on an evaluation of the first and second costs.

7. The method of claim 6 further comprising using user preference data in computing the first cost, or in computing the second cost, or in computing the first cost and computing the second cost.

8. The method of claim 6 further comprising using the state data in computing the first cost, or in computing the second cost, or in computing the first cost and computing the second cost.

9. The method of claim 1 further comprising buffering other data corresponding to the set of information to process for output at a later time.

10. The method of claim 1 further comprising modifying output data based on a current output environment as determined via the state data.

11. In a computing environment, a system comprising, a manager component that processes sets of information, and obtains state data including user presence and attention data, and an output mechanism coupled to the manager component, the output mechanism selected from a plurality of types of output mechanisms, the manager component determining whether to output data corresponding to a set of incoming information to that selected output mechanism based on a current user state as determined from the presence and attention data.

12. The system of claim 11 wherein the set of information comprises incoming information from a remote source, or incoming information from a reminder source, and wherein the state data includes audio signals, video signals, keyboard or mouse activity signals or both keyboard and mouse activity signals, calendar data, or any combination of audio signals, video signals, keyboard or mouse activity signals or both keyboard and mouse activity signals, or calendar data.

13. The system of claim 11 wherein the manager component is associated with logic that routes information to at least one of the output mechanisms and converts the information into a suitable output type as appropriate for each output mechanism.

14. The system of claim 11 wherein the manager component is associated with logic that determines from the state data whether, and if so when, to output the data corresponding to the information to each output mechanism.

15. The system of claim 11 wherein the manager component is associated with logic that computes costs related to outputting data corresponding to the information to the output mechanisms.

16. A computer-readable medium having computer-executable instructions, which when executed perform steps, comprising:
receiving incoming information for possible output;
obtaining state data indicative of a current user state with respect to presence and attention;
computing costs associated with outputting data corresponding to the incoming information to a plurality of output mechanisms; and
outputting corresponding data to at least one output mechanism, including to the output mechanism corresponding to the lowest cost computed for outputting the data.

17. The computer-readable medium of claim 16 wherein computing the costs includes using the incoming information, user preference data, the state data, or the output mechanism types, or any combination of the incoming information, user preference data, the state data, or the output mechanism types, as criteria in computing the costs.

18. The computer-readable medium of claim 16 having further computer-executable instructions comprising converting the incoming information from one format to another to match an output mechanism's output capabilities.

19. The computer-readable medium of claim 16 having further computer-executable instructions comprising adjusting the corresponding data to match an output environment as determined by current state data.

20. The computer-readable medium of claim 16 wherein the current user state with respect to presence and attention indicates the user is not present, and wherein outputting the corresponding data comprises storing the data to a persistent storage, or outputting the corresponding data to another device, or both storing the data to a persistent storage and outputting the corresponding data to another device.
